(19) United States
(12) Patent Application Publication
(10) Pub. No.: US 2026/0266420 A1
(43) Pub. Date: Sep. 10, 2026

(54) BRACKET TO SECURELY MOUNT AN AESTHETIC ENHANCEMENT TO A TIE ROD ASSEMBLY

(71) Applicant: Industrial Hardware & Specialties, Inc., Pequannock, NJ (US)

(72) Inventor: Frederic Chas. Abraham, Pequannock, NJ (US)

(73) Assignee: Industrial Hardware & Specialties, Inc., Pequannock, NJ (US)

(21) Appl. No.: 19/069,325

(22) Filed: Mar. 4, 2025

(51) Int. Cl. F16B 5/02

(52) U.S. Cl. CPC F16B 5/02

(57) ABSTRACT

Disclosed is a bracket to securely mount an aesthetic enhancement to a tie rod assembly. The bracket includes a flat plate, a tab, a slotted bracket, a clevis pin, jacking screws, and a loop. The flat plate is adaptable to be wall-mounted. The tab is welded to the flat plate. The tab includes a hole that is configured for a passage of a clevis pin. The tie rod assembly includes a clevis that is connected to the bracket by nesting the tab within a void between various clevis forks and passing the clevis pin through both sides of the clevis forks and the tab. The slotted bracket slides around the tab nested between the clevis and the bracket until the center of the distance between the jacking screws in the slotted bracket is aligned with the center of the clevis pin. The jacking screws are rotated so the jacking screws contact the surface of the flat plate component of the bracket and elevate the slotted bracket until the jacking screws apply an equal clamping force to both ears of the clevis. The loop is integrated with the bracket, extending around the clevis pin and secured to each leg of the slotted bracket.

### BACKGROUND

### Technical Field

The invention presented herein is generally directed toward a tie rod assembly wall bracket fixture to attach aesthetic elements or other non-structural enhancements. More particularly, a bracket to securely mount an aesthetic enhancement to a tie rod assembly.

### Description of the Related Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Currently, there is a notable absence of aftermarket mechanical devices explicitly crafted for mounting on tie rod assembly wall brackets, serving as interfaces to facilitate the attachment of aesthetic elements. Traditionally, any design enhancements for aesthetics must be integrated into the wall bracket during fabrication, often resulting in a permanent installation, especially if the bracket contributes to the structural integrity. The envisioned bracket offers a novel solution by allowing the mounting of aesthetic elements onto the existing wall bracket without necessitating alterations to the original installation. This disclosure encompasses various adaptations that may involve the use of adhesives or alternative mechanical devices, extending beyond clamping, and can cater to both permanent and temporary installations.

Thus, in view of the above, there is a long-felt need in the industry to address the aforementioned deficiencies and inadequacies.

It is with respect to these and other considerations that the disclosure made herein is presented.

### SUMMARY

A bracket to securely mount an aesthetic enhancement to a tie rod assembly is provided, as shown in and/or described in connection with at least one of the figures.

One aspect of the present disclosure relates to a bracket to securely mount an aesthetic enhancement to a tie rod assembly. The bracket includes a flat plate, a tab, a slotted bracket, a clevis pin, jacking screws, a loop, and an extension of the slotted bracket. The flat plate is adaptable to be wall-mounted. The tab is welded to the flat plate. The tab includes a hole that is configured for a passage of a clevis pin. The tie rod assembly includes a clevis that is connected to the bracket by nesting the tab within a void between various clevis forks and passing the clevis pin through both sides of the clevis forks and the tab, thus captivating the tab. The slotted bracket slides around the tab nested between the clevis and the bracket until the center of the distance between the jacking screws in the slotted bracket is aligned with the center of the clevis pin. The jacking screws are rotated so the jacking screws contact the surface of the flat plate component of the bracket and elevate the slotted bracket until the jacking screws apply an equal clamping force to both ears of the clevis. The loop is incorporated into the fabrication of the bracket, extending around the clevis pin and secured to each leg of the slotted bracket. The extension of the slotted bracket is mounted to the wall to provide additional rigidity, stability, and a mounting surface for the aesthetic enhancement or alternately, a support bracket for the aesthetic enhancement. In an aspect, the extension of the slotted bracket is integrated into the slotted bracket.

In an aspect, the tab hole is further configured for the passage of a clevis pin or alternatively, the shaft of a bolt or rivet, or any component that passes through the clevis pin and tab to secure the clevis to the tab.

In an aspect, the jacking screws pass through a spring to assure that constant pressure is maintained.

In an aspect, the loop is a strap that captivates the clevis pin, alternatively, a bolt or rivet, or any component that passes through the clevis pin and tab to secure the clevis to the tab.

In an aspect, the loop includes a secondary jacking screw which is rotated to apply a clamping force to the clevis pin.

In an aspect, the extension is mounted to the wall to provide the mounting surface for the aesthetic enhancement.

In an aspect, the aesthetic enhancement is directly attached to the extension of the slotted bracket or optionally to the support bracket for reinforcement and stabilization of the aesthetic enhancement, using an attachment component. Examples of aesthetic enhancement include but are not limited to a symbol, an emblem, a logo, signage, and an image-enhancing element that can alter or enhance existing aesthetics.

In an aspect, the attachment component includes either: a keyhole interlocking system, a traditional fastener, a clamping unit, and/or a combination thereof, regardless of the use of the support bracket. Accordingly, one advantage of the present invention is that the keyhole interlocking system enables the elements to be replaced quickly and without the need for tools.

Other embodiments and advantages will become readily apparent to those skilled in the art upon viewing the drawings and reading the detailed description hereafter, all without departing from the scope of the disclosure. The drawings and detailed descriptions presented are to be regarded as illustrative in nature and not in any way as restrictive.

Other features of the example embodiments will be apparent from the drawings and from the detailed description that follows.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIGS. 1A-1C illustrate 3-Axis views of a clevis assembly, in accordance with at least one embodiment.

FIGS. 2A-2D illustrate 5-sided views of an enhancement bracket, in accordance with at least one embodiment.

FIGS. 3A-3C illustrate 3-axis views of installed enhancement bracket, in accordance with at least one embodiment.

FIGS. 4A-4D illustrate 3-axis views of the installed enhancement bracket with aesthetic, in accordance with at least one embodiment.

FIG. 5 illustrates a side view of the bracket, in accordance with at least one embodiment.

### DETAILED DESCRIPTION

The disclosure will be described more fully hereinafter with reference to the accompanying drawings, in which example embodiments of the disclosure are shown, and not intended to be limiting.

Aspects of the present disclosure relate to a bracket to securely mount an aesthetic enhancement to a tie rod assembly. The device in the present disclosure is designed to offer an off-the-shelf solution for the cost-effective enhancement of any new or existing tie rod assembly wall bracket. It achieves this without compromising the structural integrity or surface finish. Another advantage of the present device is its ability to position a new design element anywhere around the wall bracket perimeter or to conceal the wall bracket. Consequently, a notable benefit of the present invention is its secure attachment solely through a clamping method, avoiding the need for welding or fasteners that would penetrate the surface finish of the wall bracket or use any conventional mechanical method. Alternatively, it can be attached using any conventional fastening system or welding. When employing clamping to mount the bracket, it can be attached and later detached without disassembling the tie rod assembly or removing a previously mounted wall bracket. The bracket in the present disclosure serves as an interface and foundation between a tie rod assembly wall bracket, allowing for the mounting of symbols, emblems, logos, signage, or images to alter or enhance the existing aesthetics.

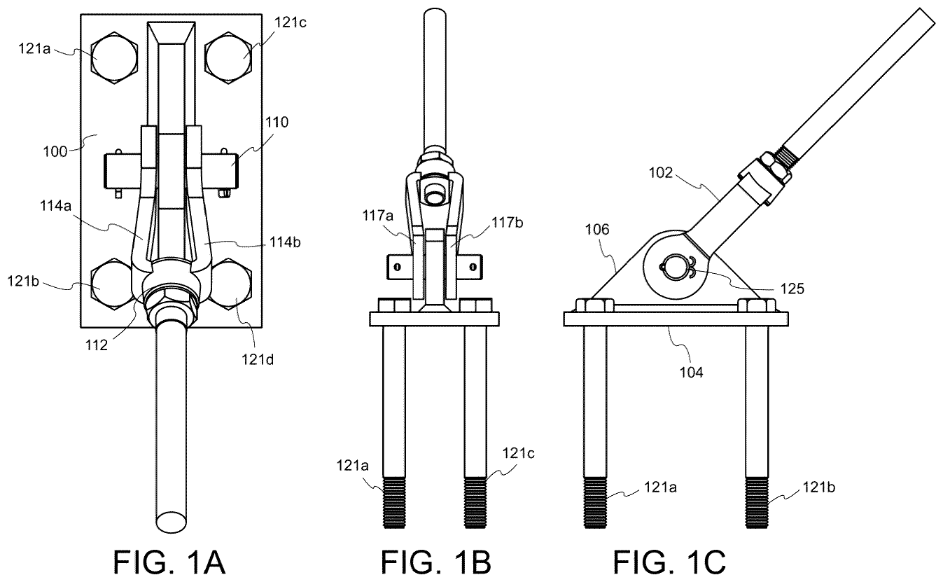

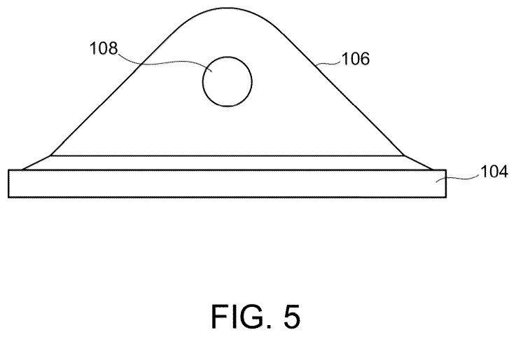

FIGS. 1A-1C illustrate 3-Axis views of a clevis assembly, in accordance with at least one embodiment. FIGS. 1A-1C depict a bracket (100), a tie rod assembly (102), a flat plate (104), a tab (106), a clevis pin (110), a plurality of bolts (121a, 121b, 121c, and 121d), and a cotter pin (125). The tie rod assembly (102) includes a clevis (112) that is connected to the bracket (100) by nesting the tab (106) within a void between various clevis forks (114a and 114b) and passing the clevis pin (110) through both sides of the clevis forks ears (117a and 117b) and the tab (106) and thus captivating the tab (106). In one embodiment, a nut is attached to a rod within the tie rod assembly. The clevis forks (114a and 114b) extend from the nut (not enumerated) and have an attribute commonly known as the clevis fork ears (117a and 117b). A pin, bolt, or rivet typically passes through the clevis fork ears (117a and 117b) to secure any tab that extends into the region between the clevis forks (114a and 114b). The tab (106) includes a hole (108) (shown in FIG. 5) that is configured for a passage of the clevis pin (110). FIG. 5 illustrates a side view of the bracket, in accordance with at least one embodiment. The tab (106) is welded to the flat plate (104). The flat plate (104) is adaptable to be wall-mounted. In an embodiment, the tab hole (108) is further configured for the passage of a clevis pin (110) or alternatively, the shaft of a bolt or rivet, or any component that passes through the clevis pin and tab to secure the clevis to the tab. The bolts (121a, 121b, 121c, and 121d) are configured to anchor the bracket (100) to the wall. In an embodiment, the clevis pin (110) is constrained by cotter pins (125) on either side of it. In another embodiment, a bolt, in lieu of using a nut or a rivet would be cross-drilled to allow the cotter pin (125) to be used on the non-headed end.

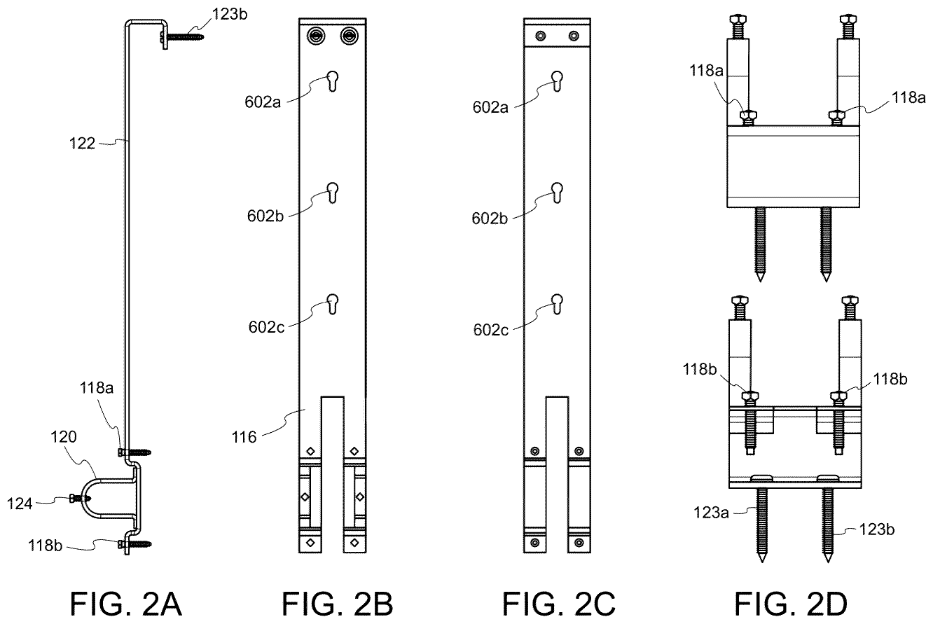

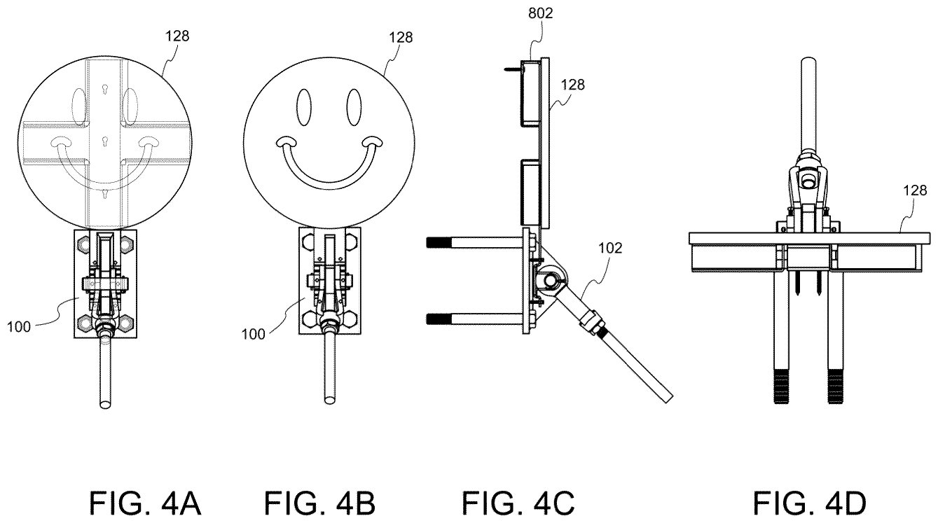

FIGS. 2A-2D illustrate 5-sided views of an enhancement bracket, in accordance with at least one embodiment. FIGS. 2A-2D are explained in conjunction with FIG. 1A-1C and 4A-4D. In an embodiment, the bracket (100) further includes various jacking screws (118a and 118b) and a plurality of screws (123a, and 123b). The slotted bracket (116) slides around the tab (106) nested between the clevis (112) and the bracket (100) until the center of the distance between the jacking screws (118a and 118b) in the slotted bracket (116) is aligned with the center of the clevis pin (110). The jacking screws (118a and 118b) are rotated so the jacking screws (118a and 118b) contact the surface of the flat plate (104) component of the bracket (100) and elevate the slotted bracket (116) until the jacking screws (118a and 118b) apply an equal clamping force to both ears (117a and 117b as shown in FIG. 1B) of the clevis (112). In an embodiment, the bracket (100) further includes an extension (122) of the slotted bracket (116). In an embodiment, the plurality of jacking screws (118a and 118b) pass through a spring to assure that constant pressure is maintained. The screws (123a, and 123b) are configured to anchor the extension of the slotted bracket (116) to the wall.

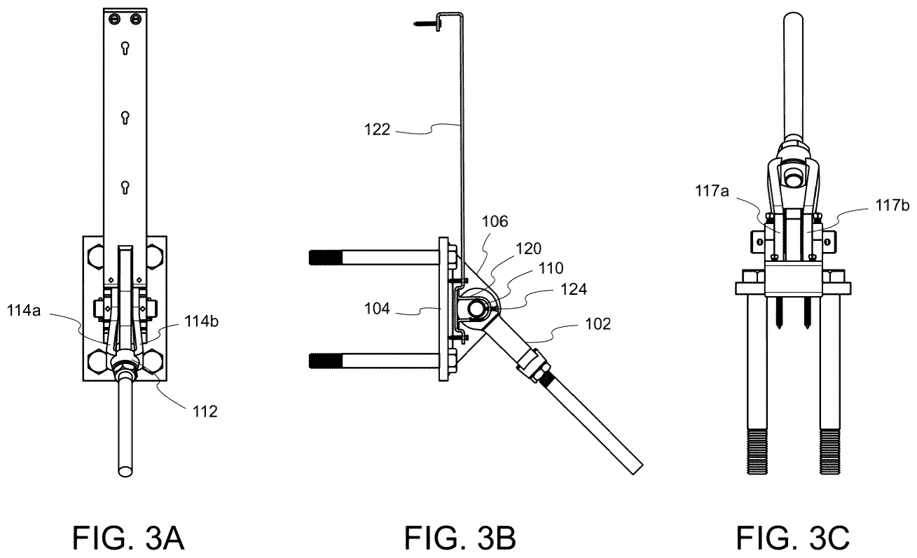

FIGS. 3A-3C illustrate 3-axis views of installed enhancement bracket, in accordance with at least one embodiment. FIGS. 3A-3C are explained in conjunction with FIG. 1A-1C. In an embodiment, the bracket (116) further includes a loop (120). The loop (120) is integrated with the bracket (116), extending around the clevis pin (110) and secured to each leg of the slotted bracket (116). According to an embodiment herein, while the dimensions of the tab hole (108) remain constant, the design of the loop (120) must accommodate the larger dimensions associated with the use of a bolt, rivet head, nut, or anything that may warrant a modification of the loop (120) for its intended functionality. In an embodiment, the loop (120) is a strap that captivates the clevis pin (110), alternatively, a bolt or rivet, or any component that passes through the clevis pin and tab to secure the clevis to the tab. According to an embodiment herein, the strap is a bilateral strap that is intended to captivate the bolt and nut assembly to be used. The loop (120) includes a secondary jacking screw (124) which is rotated to apply a clamping force to the clevis pin (110). In an embodiment, the extension (122) is mounted to the wall to provide the mounting surface for an aesthetic enhancement (128 as shown in FIGS. 4A-4D).

FIGS. 4A-4D illustrate 3-axis views of the installed enhancement bracket with aesthetic, in accordance with at least one embodiment. FIGS. 4A-4D are explained in conjunction with FIG. 1A-1C. FIGS. 4A-4D depict an aesthetic enhancement (128), and a support bracket (802). The slotted bracket (116) securely mounts the aesthetic enhancement (128) to the pre-existing tie rod bracket assembly (100). The extension (122 as shown in FIG. 3B) of the slotted bracket (116) is mounted to the wall to provide additional rigidity, stability, and a mounting surface for the aesthetic enhancement (128) or alternately, a support bracket (802) of the aesthetic enhancement (128). In an embodiment, the aesthetic enhancement (128) is directly attached to the extension (122) of the slotted bracket (116) or optionally to the support bracket (802) for reinforcement and stabilization of the aesthetic enhancement (128), using an attachment component. Examples of aesthetic enhancement (128) include but are not limited to a symbol, an emblem, a logo, signage, and an image-enhancing element that can alter or enhance existing aesthetics. In an embodiment, the attachment component includes either: a keyhole interlocking system (602a, 602b, and 602c as shown in FIG. 2B-2C), a traditional fastener, a clamping unit, and/or a combination thereof, regardless of whether the support bracket (802) is used. Accordingly, one advantage of the present invention is that the keyhole interlocking system (602a, 602b, and 602c) enables the elements to be replaced quickly and without the need for tools.

In implementation, the slotted bracket slides around the closely nested wall bracket tab between the clevis and the wall bracket until the center of the slot is aligned with the center of the clevis pin. Further, four jacking screws (two on each side of the slot) are rotated so they contact the surface of the wall bracket and elevate it until they apply an equal clamping force to both ears of the clevis. The jacking screws may pass through a spring to assure that constant pressure is maintained if there is easing by the shim. In the next step, the sheet metal loop is placed around the clevis pin (or a bolt head and nut) and affixed to each leg of the slotted bracket. Further, the sheet metal loop also contains a “jacking” screw which is rotated so it applies a clamping force to the clevis pin. Then, the long unslotted extension of the slotted bracket is mounted to the wall to provide a mounting surface (for the element or enhancement) and additional rigidity and stability. Lastly, the element (or enhancement) may be directly attached to the unslotted section of the bracket, or a backing plate is attached to the element (or enhancement) which will be used to affix the element to the slotted bracket. According to an embodiment herein, any type of fastener may be used but a keyhole interlocking system would permit quick, tool-free replacement of elements. Thus, the bracket of the present disclosure is designed to function as an interface and foundation between a tie rod assembly wall bracket, facilitating the mounting of various elements such as symbols, emblems, logos, signage, or images to enhance or alter visual aesthetics.

All terms used in the claims are intended to be given their ordinary meanings as understood by those knowledgeable in the technologies described herein unless an explicit indication to the contrary is made herein. In particular, the use of singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

In the foregoing description, it will be readily appreciated by those skilled in the art that modifications may be made to the invention without departing from the concepts disclosed herein. Such modifications are to be considered as included in the following claims, unless these claims by their language expressly state otherwise.

That which is claimed is:

1. A bracket (110) to securely mount an aesthetic enhancement (128) to a tie rod assembly (102), comprising:
a flat plate (104) adaptable to be wall mounted;
a tab (106) welded to the flat plate (104), wherein the tab (106) comprises a hole (108) configured for a passage of a clevis pin (110), wherein the tie rod assembly (102) comprises a clevis (112) that is connected to the bracket (100) by nesting the tab (106) within a void between a plurality of clevis forks (114a and 114b) and passing the clevis pin (110) through a plurality of clevis fork ears (117a and 117b) on both the clevis forks (114a and 114b) and the tab (106) and thus captivating the tab (106);
a slotted bracket (116) slides around the tab (106) nested between the clevis (112) and the bracket (100) until the center of the distance between a plurality of jacking screws (118a and 118b) in the slotted bracket (116) is aligned with the center of the clevis pin (110);
the plurality of jacking screws (118a and 118b) rotated so the plurality of jacking screws (118a and 118b) contact the surface of the flat plate (104) component of the bracket (100) and elevate the slotted bracket (116) until the plurality of jacking screws (118a and 118b) apply an equal clamping force to both the clevis fork ears (117a and 117b) of the clevis (112);
a loop (120) secured around the clevis pin (110) and affixed to each leg of the slotted bracket (116); and
an extension (122) of the slotted bracket (116) is mounted to the wall to provide additional rigidity, stability, and a mounting surface for the aesthetic enhancement (128) or alternately, a support bracket (802) of the aesthetic enhancement (128).

2. The device according to claim 1, wherein the hole (108) is further configured for the passage of a clevis pin (110) or alternatively, the shaft of a bolt or rivet.

3. The bracket according to claim 1, wherein the plurality of jacking screws (118a and 118b) pass through a spring to assure that constant pressure is maintained.

4. The bracket according to claim 1 or claim 2, wherein the loop (120) is a strap that captivates the clevis pin (110), alternatively, a bolt or rivet.

5. The bracket according to claim 1, wherein the loop (120) comprises a secondary jacking screw (124) which is rotated to apply a clamping force to the clevis pin (110).

6. The bracket according to claim 1, wherein the extension (122) is mounted to the wall to provide the mounting surface for the aesthetic enhancement (128).

7. The bracket according to claim 1, wherein the aesthetic enhancement (128) is directly attached to the extension (122) of the slotted bracket (116) or optionally to the support bracket (802) for reinforcement and stabilization of the aesthetic enhancement, using an attachment component.

8. The bracket according to claim 1, wherein the attachment component comprising either: a keyhole interlocking system (602a and 602b), a traditional fastener, a clamping unit, and/or a combination thereof, regardless of the use of the support bracket (802).

9. The bracket according to claim 1, wherein the aesthetic enhancement (128) comprises: a symbol, an emblem, a logo, a signage, and an image-enhancing element that can alter or enhance an existing aesthetics.
